(19) United States
(12) Patent Application Publication
(10) Pub. No.: US 2009/0064304 A1
(43) Pub. Date: Mar. 5, 2009

(54) PORT ACCESS USING USER DATAGRAM PROTOCOL PACKETS

(75) Inventors: Joseph Chyam Cohen, Burbank, CA (US); James David Casaburi, Rancho Palos Verdes, CA (US)

Correspondence Address: FISH & RICHARDSON, PC, P.O. BOX 1022, MINNEAPOLIS, MN, 55440-1022, US

(73) Assignee: CODEUX, INC., Las Vegas, NV (US)

(21) Appl. No.: 11/815,552

(22) PCT Filed: Oct. 6, 2006
(86) PCT No.: PCT/US2006/039818

§ 371 Date: Oct. 7, 2008

Related U.S. Application Data
(60) Provisional application No. 60/724,661, filed on Oct. 7, 2005.

(51) Int. Cl. H04L 9/00

(52) U.S. Cl. 726/11

(57) ABSTRACT

Communication through an intervening firewall can be achieved by transmitting an outbound datagram through a port of a firewall to open a circuit through the firewall, receiving an inbound datagram through the open circuit from an application, wherein the application is external to the firewall, and communicating with the application through the open circuit. Also, the application can comprise a client application and the firewall can comprise a server firewall. Further, the client application can transmit an outbound datagram through a port of an associated client firewall to open a circuit through the client firewall and can receive one or more datagrams through the open circuit of the client firewall. Additionally, the port of the server firewall and the port of the client firewall can correspond to the same port number.

### RELATED APPLICATION

This application claims priority to U.S. Provisional Application Ser. No. 60/724,661, filed Oct. 7, 2005, the disclosure of which is incorporated herein by reference.

### BACKGROUND

The present disclosure relates to communication between networked computers, and to systems and methods for facilitating such communication in an environment that includes one or more firewalls.

The User Datagram Protocol (UDP) was originally specified in 1980 by request for comments RFC-768: user datagram protocol. As with the Transmission Control Protocol (TCP), UDP is a transport layer protocol that resides at layer 4 of the Open Systems Interface (OSI) reference model. UDP was defined to create a datagram mode of packet-switched computer communication in the environment of an interconnected set of computer networks. The UDP protocol is premised on the assumption that the Internet Protocol (IP), or layer 3 of the OSI reference model, is used as the underlying protocol.

UDP identifies a specific process running on a specific computer. The IP protocol is operable to address a transmitted UDP message by associating additional IP header information with the UDP message, such as a source IP address and a destination IP address. Therefore, a UDP message is encapsulated within an IP datagram for transmission over a network. UDP, however, is not limited to communication between two specific end-points. In accordance with the UDP protocol, a one-to-many interaction can be implemented by configuring a single sender to transmit messages to many recipients, such as through broadcast or multicast addressing. Further, a many-to-one interaction can be implemented by configuring a single recipient to receive UDP messages from a plurality of senders. Additionally, a many-to-many interaction can be implemented using a combination of the one-to-many and many-to-one techniques.

Although UDP and TCP both reside at the transport layer of the OSI reference model, the transmission of data using UDP is much faster than the transmission of the same data using TCP. Therefore, UDP is often selected as the communication protocol for use with time sensitive applications, such as video conferencing and streaming audio. In part, UDP realizes an advantage in speed over TCP because it features far less control over the individual message portions, also referred to as datagrams or segments, that are transmitted across a network. For example, UDP does not include a facility for monitoring message delivery. Therefore, the protocol does not take any corrective action if a UDP datagram fails to reach an intended recipient. Further, because a connection is not a prerequisite to the transmission of data, UDP also does not introduce any delay in order to establish a connection between the end-points that are involved in the communication. Additionally, UDP does not sequence datagrams such that they can be reassembled by the recipient. Therefore, it is not necessary for the sender to retransmit datagrams that are not delivered.

A UDP datagram is transmitted in the form of a single unit of binary data. For example, a UDP datagram can include a header portion and a data portion. The header portion can be represented as the first portion of the datagram and can include multiple fields of information. One such field can be used to identify a source port number associated with the datagram, while another field can be used to identify a corresponding destination port number. A UDP port number identifies a single instance of an application (or process) associated with a single system. The port numbers used by the UDP protocol are independent of the underlying operating system associated with the system hosting the application.

A UDP port number can be used by an application program to identify a specific channel for data that is transmitted and received by the application program. The application program that is transmitting the data can transmit one or more UDP datagrams through the source port. Similarly, when a datagram is received, the host system can determine which application program is associated with the destination port specified in the datagram. The one or more items of data included in the datagram can then be delivered to the appropriate application program.

The UDP protocol supports representations of port numbers that can be expressed using two bytes of binary information, thereby permitting the identification of ports numbered between 0 and 65,535. Some of the 65,536 available port numbers have been registered and are thus reserved for identification of specific applications. Such registered port numbers are also referred to as static port numbers or well-known ports, and each of these port numbers is always designated for use with a particular application. Other port numbers are unregistered and, as such, their use is not limited to any particular application. An application can designate an unregistered port number for any type of use. Unregistered port numbers also can be referred to as dynamic port numbers.

One or more networked computers can be screened from other networked computers, such as those on the Internet, by a firewall. A firewall can be configured to regulate the messages that are permitted to reach the one or more computers connected to the network behind the firewall based on certain attributes, including message type, message content, sender, and intended recipient. For example, the TCP protocol requires that a connection be established before information associated with an application can be exchanged over a network. Therefore, it is possible to configure a firewall that exists in the connection path between two networked computers in a manner that will deny such a connection and thereby protect one or more of the computers located behind the firewall.

Additionally, a firewall can be configured to deny a connection between computers in order to limit the use of network resources, such as bandwidth and processing cycles, by unauthorized or undesirable applications. The arbitrary imposition of such limitations, however, can make it difficult or impossible to make effective use computing resources. For example, requests to establish virtual private network (VPN) connections are often refused by the network from which they originate because the contents of one or more messages cannot be verified. As such, a user who is away from her primary network can be denied a VPN connection because the network to which she is connected will not allow a connection to be established.

### SUMMARY

The present inventors recognized the need to implement strategies that permit communication between networked computers through at least one firewall. Accordingly, the techniques and apparatus described here implement algorithms for facilitating communication between two or more networked computers through one or more intervening firewalls.

In general, in one aspect, the techniques can be implemented to include transmitting an outbound datagram through a port of a firewall to open a circuit through the firewall, receiving an inbound datagram through the open circuit from an application, wherein the application is external to the firewall, and communicating with the application through the open circuit.

The techniques also can be implemented such that the port comprises a standardized port corresponding to a registered port number. Further, the techniques can be implemented such that the application comprises a client application and the firewall comprises a server firewall. Additionally, the techniques can be implemented to include transmitting, by the client application, an outbound datagram through a port of a client firewall to open a circuit through the client firewall and receiving, by the client application, one or more datagrams through the open circuit of the client firewall. The techniques further can be implemented such that the port of the server firewall corresponds to the port of the client firewall.

The techniques also can be implemented to include distributing to the client application data comprising one or more of software, streaming audio, and streaming video. The techniques further can be implemented to include transmitting one or more additional outbound datagrams through the open circuit to reset a TTL counter associated with the firewall. Additionally, the techniques can be implemented to include receiving an inbound datagram through the open circuit from a second application, wherein the second application is external to the firewall and communicating with the second application through the open circuit.

In general, in another aspect, the techniques can be implemented as a computer program product, encoded on a computer-readable medium, operable to cause data processing apparatus to perform operations comprising transmitting an outbound datagram through a port of a firewall to open a circuit through the firewall, receiving an inbound datagram through the open circuit from an application, wherein the application is external to the firewall, and communicating with the application through the open circuit.

The techniques also can be implemented such that the port comprises a standardized port corresponding to a registered port number. Further, the techniques can be implemented such that the application comprises a client application and the firewall comprises a server firewall. Additionally, the techniques can be implemented to be further operable to cause data processing apparatus to perform operations comprising transmitting, by the client application, an outbound datagram through a port of a client firewall to open a circuit through the client firewall and receiving, by the client application, one or more datagrams through the open circuit of the client firewall. The techniques further can be implemented such that the port of the server firewall corresponds to the port of the client firewall.

The techniques also can be implemented to be further operable to cause data processing apparatus to perform operations comprising distributing to the client application data comprising one or more of software, streaming audio, and streaming video. Moreover, the techniques can be implemented to be further operable to cause data processing apparatus to perform operations comprising transmitting one or more additional outbound datagrams through the open circuit to reset a TTL counter associated with the firewall. Additionally, the techniques can be implemented to be further operable to cause data processing apparatus to perform operations comprising receiving an inbound datagram through the open circuit from a second application, wherein the second application is external to the firewall and communicating with the second application through the open circuit.

In general, in another aspect, the techniques can be implemented as a system comprising a firewall, an external computer hosting an external application, and an internal computer hosting an internal application configured to perform operations comprising transmitting an outbound datagram through a port of the firewall to open a circuit through the firewall, receiving an inbound datagram through the open circuit from the external application, and communicating with the external application through the open circuit, wherein the external computer is coupled to a network outside of the firewall and the internal computer is coupled to the network inside of the firewall.

The techniques also can be implemented such that the internal application is further configured to perform operations comprising receiving an inbound datagram through the open circuit from at least another external application and communicating with the at least another external application through the open circuit. Further, the techniques can be implemented such that the internal application is further configured to perform operations comprising distributing to the external application data comprising one or more of software, streaming audio, and streaming video. Additionally, the techniques can be implemented such that the internal application is further configured to perform operations comprising transmitting one or more additional outbound datagrams through the open circuit to reset a TTL counter associated with the firewall.

The techniques described in this specification can be implemented to realize one or more of the following advantages. The techniques can be implemented to permit two networked computers hosting multi-player online game (MPOG) applications to communicate directly through one or more intervening firewalls. The techniques also can be implemented such that a plurality of computers can be utilized to distribute information, such as software or streaming media, through an intervening firewall to one or more additional computers. Additionally, the techniques can be implemented to increase the security of a connection between remote computers, such as a VPN connection, by ensuring that only trusted users are permitted to establish such a connection through a firewall. The techniques also can be implemented to permit swarm computing between a plurality of networked computers through one or more intervening firewalls. Further, the techniques can be implemented to permit a computer behind a firewall to open an incoming connection without the need to specially configure the firewall.

These general and specific techniques can be implemented using an apparatus, a method, a system, or any combination of an apparatus, methods, and systems. The details of one or more implementations are set forth in the accompanying drawings and the description below. Further features, aspects, and advantages will become apparent from the description, the drawings, and the claims.

### BRIEF DESCRIPTION OF THE DRAWINGS

FIG. 1 depicts a UDP datagram.

FIGS. 2-3 present systems of networked computers.

FIG. 4 depicts a data distribution system in which a circuit can be opened through one or more firewalls.

FIG. 5 is a flowchart describing a method of communicating through at least one intervening firewall.

Like reference symbols indicate like elements throughout the specification and drawings.

### DETAILED DESCRIPTION

The UDP communication protocol exercises less control over individual message portions, such as datagrams or segments, than the TCP communication protocol. UDP also differs from TCP in that it is a connectionless protocol. In UDP, the transmitting application, or sender, does not contact the receiving application, or destination, before transmitting a message. As discussed above, the transmitting and receiving applications are hosted on networked computers, which can be separated by any distance. Because “hand-shaking” does not precede communication in UDP, a virtual circuit, or transmission path, is therefore also not established between the computers hosting the transmitting application and the receiving application. As such, an application can be configured to transmit one or more datagrams to one or more intended recipients without regard to any confirmation or response.

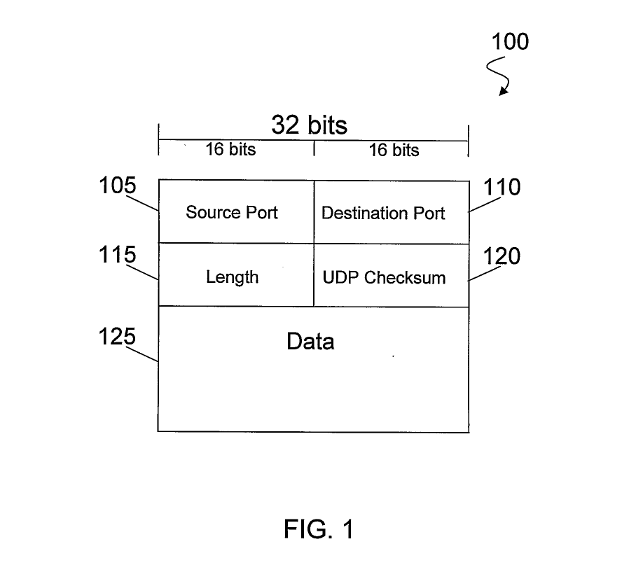

FIG. 1 depicts a datagram 100 that can be transmitted using the UDP communication protocol. The datagram 100 includes a source port field 105 that identifies the application (or process) that transmitted the datagram 100 and a destination port field 110 that identifies the application to which the datagram 100 is to be delivered. The datagram 100 also includes a length field 115, which identifies the combined length of the datagram header and data portions. The length field 115 is represented in terms of the number of bytes comprising the datagram 100.

Further, the datagram 100 includes a checksum field 120, which can be used to determine whether errors were introduced into the datagram 100 during transmission. The checksum can be calculated before the datagram 100 is transmitted, based on a portion of the bits included in the datagram 100. The checksum also can be calculated by the application receiving the datagram, using the same method. If the checksum calculated by the receiving application differs from the checksum included in the datagram 100 header, the receiving application is thereby notified that one or more bits of information included in the datagram were altered during transmission. The use of a checksum is optional in UDP. If the checksum field 120 is not used to store a checksum, the bits comprising the checksum field 120 are all set to one. In another implementation, if the checksum field 120 is not used to store a checksum, the checksum field 120 can be used to store additional data.

The source port field 105, the destination port field 110, the length field 115, and the checksum field 120 are each configured to be 16-bits long. Additionally, the datagram 100 includes a data field 125. The length of a UDP datagram is flexible and depends on the application with which it is associated. Therefore, as the length of the header portion is fixed, the maximum length of the data field 125 depends on the maximum length of the IP datagram that will be used to encapsulate the datagram 100. Further, as discussed above, RFC 768 specifies that the source port is an optional field and therefore is not required to contain a number indicating the port associated with the application transmitting the datagram 100. If a source port is not specified in the source port field 105 of the datagram 100, the source port field 105 can be padded, or filled, with the appropriate number of binary zeros, e.g. 16 bits.

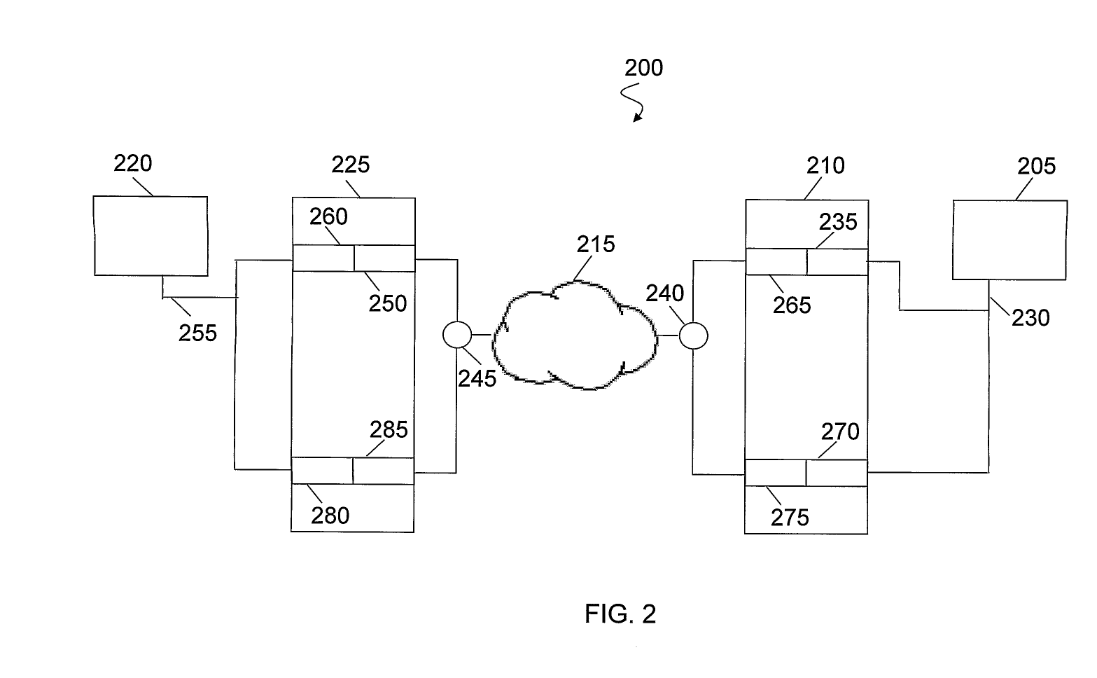

FIG. 2 presents a system of networked computers 200, in which a first computer 205 is connected to the Internet 215 through a first firewall 210. The system of networked computers 200 also includes a second computer 220 that is connected to the Internet 215 through a second firewall 225. The first computer 205 and the first firewall 210 can be geographically separated from the second computer 220 and the second firewall 225 by any distance. Because they are networked, an application (or process) hosted on the first computer 205, such as a user application, can address and transmit one or more UDP datagrams to an application hosted on the second computer 220, such as a server application. In order for the application hosted on the second computer 220 to receive one or more of the datagrams transmitted by the application hosted on the first computer 205, however, the application hosted on the first computer 205 must address the datagrams using a port number associated with the application hosted on the second computer 220. Additionally, the second firewall 225 must be configured to pass the one or more datagrams transmitted by the application hosted on the first computer 205 through to the application hosted on the second computer 220.

The port numbers to which datagrams should be addressed have been standardized and registered by the Internet Engineering Task Force (IETF) for a plurality of common applications. For example, the IETF has indicated that port number 25 corresponds to the Simple Mail Transfer Protocol (SMTP) and that port number 110 corresponds to the Post Office Protocol (POP). Therefore, if the application hosted on the first computer 205 and the application hosted on the second computer 220 are associated with a registered port number, the applications can use the standardized port to communicate.

In another implementation, a connection manager can be employed to identify an unregistered port number that can be used for addressing one or more datagrams. For example, a connection manager can include a plurality of predetermined assignments, each of which associates an unregistered port number with a particular application. If an unregistered port number is used by the transmitting application, however, the unregistered port number also must be associated with the receiving application. As such, applications that have access to compatible versions of the connection manager also can be configured to communicate using port numbers that have not been standardized for the UDP protocol. Further, the connection manager also can include predetermined assignments reflecting standardized port numbers. The connection manager can be separate from the application transmitting the one or more datagrams, such as a distinct application. In another implementation, the connection manager can be integrated with the transmitting and receiving applications.

The second firewall 225 also must be configured to pass the one or more datagrams transmitted by the application running on the first computer 205 through to the application hosted on the second computer 220. Additionally, in order to achieve bi-directional communication, the first firewall 210 must permit the datagrams transmitted by the second computer 220 to pass through to the first computer 205. As discussed above, firewalls can be configured to block certain types of messages as well as messages from certain senders, both known and unknown. If a firewall is configured to block one or more messages that are used in connection with an application, it can be difficult for that application to carry out the desired communication and perform the desired operations.

The UDP protocol, however, permits a computer located inside of a network to open a circuit (or data path) through a firewall on a specific port simply by transmitting an outbound datagram through that port. Once open, the circuit will also permit incoming datagrams addressed to the specific port to pass through the firewall. Therefore, a computer on a network can be made available to receive communications from a computer outside of that network by transmitting an outbound datagram through a predetermined port of an intervening firewall. For example, the first computer 205 can be configured to open a circuit through the first firewall 210 by transmitting an outbound UDP datagram over a first communication path 230 to the first firewall 210. The outbound UDP datagram can be directed to an outbound standard port 235, such as port number 6620.

As discussed above, the outbound standard port 235 can be the standard port associated with the user application hosted on the first computer 205 or a predetermined unregistered port number. If the first firewall 210 supports the UDP protocol, the transmitted datagram is permitted to pass through the outbound standard port 235 and is forwarded to the Internet 215 via an Internet access point 240. By permitting the datagram to pass through, the first firewall 210 also opens the corresponding inbound standard port 265. As a result, a circuit through the first firewall 210 is created that can be used by the first computer 205 for bidirectional communication with one or more computers located on a network outside of the first firewall 210.

The second computer 220 can be configured to operate as a server for one or more types of information or services, including streaming audio, streaming video, and downloadable files. The second computer 220 need not be a conventional server, but rather can be any computer that includes information accessible to one or more other computers, such as streaming content or files. The second computer 220 can be configured to anticipate receiving one or more service requests from computers located outside of the firewall behind which the second computer 220 is located. Therefore, the second computer 220 can open a circuit through the second firewall 225 (or server firewall) so that the service requests can be received. The second computer 220 can open the circuit by transmitting an outbound UDP datagram over a second communication path 255 to the second firewall 225.

As with the first computer 205, the second computer 220 can transmit the outbound UDP datagram on an outbound standard port 260, such as port number 6620. The outbound standard port 260 can be the standard port associated with the user application hosted on the first computer 205 or a predetermined unregistered port number. In an implementation, it is possible for the second computer 220 to function as a server for more than one application. Therefore, it is possible for the second computer 220 to open multiple circuits through the second firewall 225, corresponding to the applications for which the second computer 220 is configured to function as a server.

If the second firewall 225 supports the UDP protocol, the outbound datagram is permitted to pass through the outbound standard port 260 and is forwarded to the Internet 215 via an Internet access point 245. By permitting the datagram to pass through, the second firewall 225 also opens the corresponding inbound standard port 250. As a result, a circuit through the second firewall 225 is created that can be used by the second computer 220 for communication with one or more networked computers that are located outside of the second firewall 225. Because a compatible communication manager can be associated with both the application hosted on the first computer 205 and the application hosted on the second computer 220, a corresponding port number can be defined even though a standardized port number has not been registered for the application in the UDP protocol.

Once the outbound standard port 235 and the inbound standard port 265 associated with the first firewall 210 and the outbound standard port 260 and the inbound standard port 250 associated with the second firewall 225 have been opened, the first computer 205 and the second computer 220 can freely communicate with one another. For example, the first computer 205 can access the information made available on the second computer 220, such as the streaming audio content, and can provide the information to a user through the application hosted on the first computer 205.

It also is possible to configure a firewall, such as the first firewall 210 or the second firewall 225, to permit a circuit to remain open only for a predetermined period of time. For example, the first firewall 210 can maintain a time-to-live (TTL) counter that is associated with an open circuit in the first firewall 210. If the TTL counter expires, the associated circuit through the first firewall 210 is closed and subsequent datagrams addressed to the corresponding port number are discarded instead of being allowed to pass through. As a result, communication will be disrupted until a new circuit through the first firewall 210 has been established to serve the application.

The TTL counter can be reset, however, by transmitting a datagram through the existing circuit. For example, a datagram including the same source and destination ports as the initial datagram used to establish the circuit can be transmitted through the first firewall 210 to reset the TTL counter. Further, the datagram also can contain the same IP address information as the initial datagram. In this manner, an application can be configured to determine the duration of the TTL counter by transmitting datagrams through the circuit at predetermined intervals, such as increasing or decreasing intervals. Once the duration of the TTL counter associated with a firewall, such as the first firewall 210 or the second firewall 225, has been determined, a datagram can be transmitted through the circuit in that firewall at any interval that is shorter than the duration of the TTL counter. In this manner, the circuit through the firewall can be maintained even when it is not being used for communication with an application hosted on a computer system located outside of the firewall.

In another implementation, the first computer 205 and the second computer 220 can use an initial communication to negotiate a subsequent communication session on a different port. For example, the first computer 205 can transmit a request for a verified communication session to the second computer 220 through the outbound standard port 235 associated with the first firewall 210. Because the second computer 220 is configured to maintain an open circuit through the second firewall 225 on the inbound standard port 250, the communication request transmitted by the first computer 205 is permitted to pass through the second firewall 225. The communication request transmitted by the first computer 205 can include information used to verify the user of the first computer 205, including one or more of a user name, a password, and a source port. In another implementation, additional security information, such as a certificate or an authentication code, also can be included in the communication request.

Upon receiving, and optionally verifying, the request transmitted by the first computer 205, the second computer 220 can transmit a response comprising one or more datagrams. As the first computer 205 has established a circuit through the first firewall 210 by transmitting one or more outbound datagrams, the response from the second computer 220 is permitted to pass through the inbound standard port 265 of the first firewall 210. The response transmitted by the second computer 220 also can specify a session port, different from the standard port, through which all subsequent communication between the first computer 205 and the second computer 220 will be transmitted for the remainder of the communication session. The session port can be selected from the range of dynamic ports that have not been assigned to a specific application as a standard port.

As described above, the first computer 205 also can transmit a datagram through an outbound session port 270, such as a session port specified by the second computer 220, to open the inbound session port 275 and thus create a circuit through the first firewall 210 on the specified session port. Similarly, the second computer 220 can transmit a datagram through the outbound session port 280 to open the inbound session port 285 and thus create a circuit through the second firewall 225 on the specified session port. The first computer 205 and the second computer 220 can then transmit datagrams to one another through the circuits existing in the first firewall 210 and the second firewall 225.

As long as the first firewall 210 and the second firewall 225 support the UDP protocol, the transmitted datagrams cannot be blocked. Additionally, the first computer 205 can continue to periodically transmit datagrams through the outbound session port 270 of the first firewall 210 and the second computer 220 can continue to periodically transmit datagrams through the outbound session port 280 of the second firewall 225 as required in order to ensure that the respective TTL counters associated with the circuits do not expire and thereby prematurely terminate the communication session.

In another implementation, the first computer 205 and the second computer 220 can be separated by only one firewall. In such an implementation, a circuit can be opened through the firewall by the computer located inside of the network protected by that firewall. For example, the first computer 205 can exist on a network protected by the first firewall 210 and the second computer 220 can exist on the Internet without an additional firewall. In order for the first computer 205 and the second computer 220 to communicate, the first computer 205 can open a circuit through the first firewall as described above. This technique can be applied to permit communication over a wide variety of network configurations.

It also is possible for the source port associated with a datagram to be identified differently to a device outside of the network on which the application that generated the datagram is operating. For example, an intervening firewall can translate the source port number associated with a datagram as the datagram is passed through the firewall to an external network, such as the Internet. Similarly, datagrams transmitted by an application existing outside of the firewall that are addressed to an application hosted on computer located inside of the firewall will be addressed to the destination port number that is externally known. As such, when a datagram is received by a firewall, the destination port number can be translated from the externally known port number to the internally referenced port number.

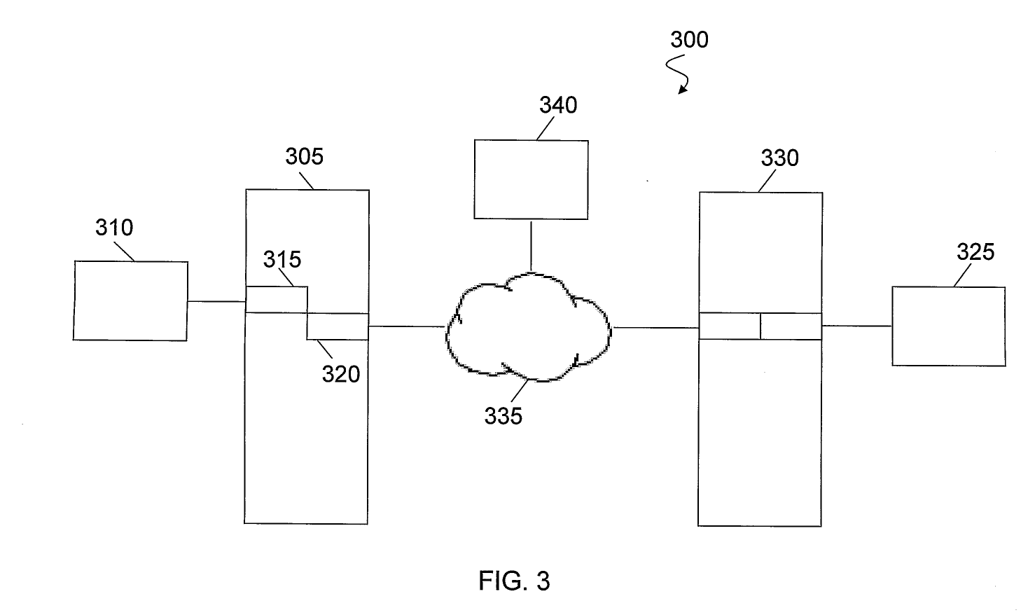

FIG. 3 depicts a system of networked computers 300 in which a first firewall 305 functions as a network address translator (“NAT”). An application hosted on a server 310 located behind the first firewall 305 can be configured to receive a message, such as a communication request, on a specific standard port number. So that it is able to receive the inbound message, the application hosted on the server 310 can periodically transmit a datagram through the corresponding standard outbound port 315, such as port number 6620, of the first firewall 305 to open or maintain a circuit. Because the first firewall 305 acts as a NAT, however, the inbound port number associated with the application corresponds to a translated inbound port 320, such as port number 6621. Therefore, the resulting circuit through the first firewall 305 will be characterized by different inbound and outbound port numbers.

An application hosted on a client computer 325 located inside of a second firewall 330 can be configured to transmit a message, e.g. a communication request, to the application hosted on the server 310. The client computer 325 addresses the datagram comprising the message to the application hosted on the server 310 using the standard port number associated with that application, e.g. port number 6620, as the destination port. As a result of the translation performed by the first firewall 305, however, the destination port specified by the application hosted on the client computer 325 is incorrect. Therefore, the first firewall 305 will discard the datagram.

In order to identify the translated inbound port 320 to one or more other applications seeking to communicate, the application hosted on the server 310 can transmit a datagram to a communication server 340 that is connected directly to a network outside of the first firewall 305, such as the Internet 335. Upon receiving the datagram transmitted by the application hosted on the server 310, the communication server 340 can determine the associated addressing information, including the source port and the destination port. The communication server 340 can then provide the addressing information corresponding to the application hosted on the first computer 310 to any other applications desiring to communicate, such as the client computer 325.

Permitting an application to open a circuit through an associated firewall can facilitate the distribution of information across a network. For example, a computer that typically functions as a client also can be configured to operate as a server to distribute a wide variety of information, including software, streaming video content, and streaming audio content. Moreover, because such a distribution technique does not rely on dedicated servers with high-bandwidth infrastructure, the information can be distributed in an adaptive manner.

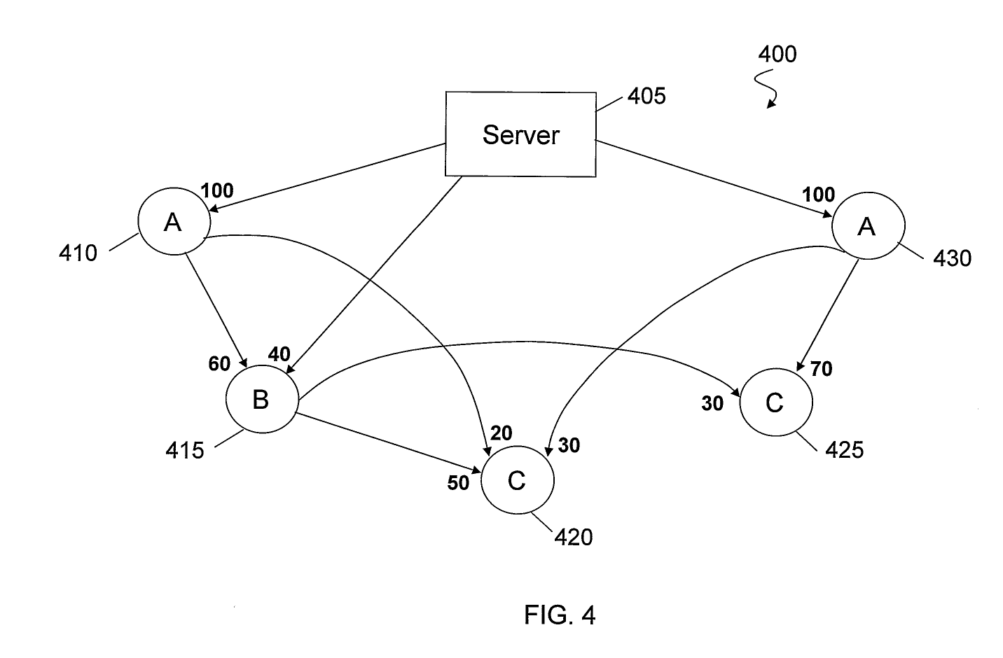

FIG. 4 depicts a data distribution system 400 in which a plurality of participating client systems also can be configured to act as servers for one or more other client systems. In order to ensure that a communication request transmitted by an application hosted on a client system can be received, a corresponding application hosted on a participating client system located behind a firewall can open a circuit through that firewall on an appropriate port by transmitting one or more datagrams.

The primary server 405 represents an accessible server that acts as the source of the data that is to be distributed, such as a static data file or streaming content. An application hosted on the primary server 405 can be configured to receive one or more communication requests and to respond to such requests by transmitting the data to be distributed using one or more datagrams. A number of client systems, e.g. client systems 410 and 430, that receive 100 percent of the data directly from the primary server 405 represent a first class. An application hosted on the participating client systems in the first class can further be configured to distribute the data to other client systems.

A second class of client systems, e.g. client system 415, can be configured to receive one portion of the data from the primary server 405 and another portion of the data from one or more participating client systems, such as a participating client system included in the first class. For example, the client system 415 receives 40 percent of the data from the primary server 405 and 60 percent of the data from the client system 410. The percentage of the total data received from a particular source can be adjusted based on relevant factors, such as loading, proximity, and available bandwidth.

It also is possible to include a third class of client systems, e.g. client systems 420 and 425, which can be configured to receive all of the data from one or more participating client systems. Client systems in the third class do not interact with the primary server 405. For example, the client system 425 can receive 70 percent of the data from the client system 430 included in the first class and 30 percent of the data from the client system 415 included in the second class. As a result, the demand placed on the primary server 405 in the data distribution system 400 can be controlled to ensure that it does not exceed the capabilities of the primary server 405. In an implementation, a client system also can be configured to transmit a communication request to one or more alternate servers if a default server does not respond to a communication request. In another implementation, the data distribution system 400 can be used for other purposes, including swarm computing and on-line gaming.

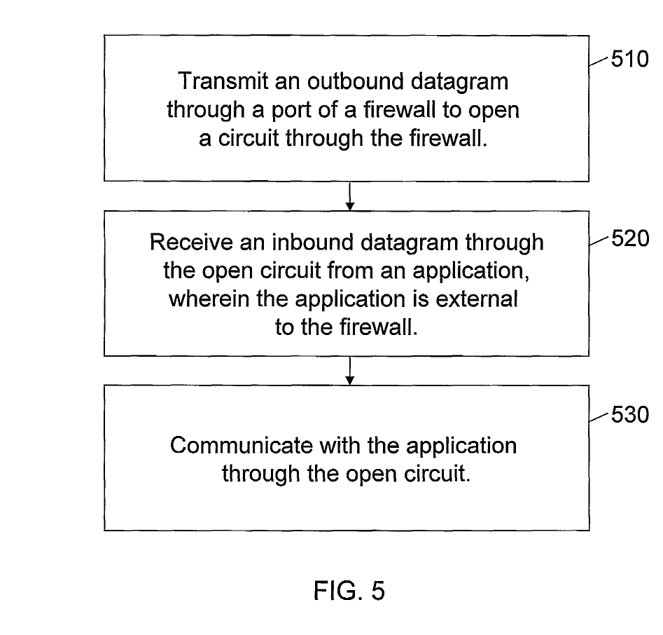

FIG. 5 describes a method of communicating through at least one intervening firewall. In a first step, an outbound datagram can be transmitted through a port of a firewall to open a circuit through the firewall (510). In a second step, an inbound datagram can be received through the open circuit from an application, wherein the application is external to the firewall (520). Once the inbound datagram has been received through the open circuit, a third step is to communicate with the application through the open circuit (530).

A number of implementations have been disclosed herein. Nevertheless, it will be understood that various modifications may be made without departing from the spirit and scope of the claims. Accordingly, other implementations are within the scope of the following claims.

What is claimed is:

1. A method of communicating through an intervening firewall, the method comprising:
transmitting an outbound datagram through a port of a firewall to open a circuit through the firewall;
receiving an inbound datagram through the open circuit from an application, wherein the application is external to the firewall; and
communicating with the application through the open circuit.

2. The method of claim 1, wherein the port comprises a standardized port corresponding to a registered port number.

3. The method of claim 1, wherein the application comprises a client application and the firewall comprises a server firewall.

4. The method of claim 3, further comprising:
transmitting, by the client application, an outbound datagram through a port of a client firewall to open a circuit through the client firewall; and
receiving, by the client application, one or more datagrams through the open circuit of the client firewall.

5. The method of claim 4, wherein the port of the server firewall corresponds to the port of the client firewall.

6. The method of claim 3, further comprising:
distributing to the client application data comprising one or more of software, streaming audio, and streaming video.

7. The method of claim 1, further comprising:
transmitting one or more additional outbound datagrams through the open circuit to reset a TTL counter associated with the firewall.

8. The method of claim 1, further comprising:
receiving an inbound datagram through the open circuit from a second application, wherein the second application is external to the firewall; and
communicating with the second application through the open circuit.

9. A computer program product, encoded on a computer-readable medium, operable to cause data processing apparatus to perform operations comprising:
transmitting an outbound datagram through a port of a firewall to open a circuit through the firewall;
receiving an inbound datagram through the open circuit from an application, wherein the application is external to the firewall; and
communicating with the application through the open circuit.

10. The computer program product of claim 9, wherein the port comprises a standardized port corresponding to a registered port number.

11. The computer program product of claim 9, wherein the application comprises a client application and the firewall comprises a server firewall.

12. The computer program product of claim 11, further operable to cause data processing apparatus to perform operations comprising:
transmitting, by the client application, an outbound datagram through a port of a client firewall to open a circuit through the client firewall; and
receiving, by the client application, one or more datagrams through the open circuit of the client firewall.

13. The computer program product of claim 12, wherein the port of the server firewall corresponds to the port of the client firewall.

14. The computer program product of claim 11, further operable to cause data processing apparatus to perform operations comprising:
distributing to the client application data comprising one or more of software, streaming audio, and streaming video.

15. The computer program product of claim 9, further operable to cause data processing apparatus to perform operations comprising:
transmitting one or more additional outbound datagrams through the open circuit to reset a TTL counter associated with the firewall.

16. The computer program product of claim 9, further operable to cause data processing apparatus to perform operations comprising:
receiving an inbound datagram through the open circuit from a second application, wherein the second application is external to the firewall; and
communicating with the second application through the open circuit.

17. A system comprising:
a firewall;
an external computer hosting an external application; and
an internal computer hosting an internal application configured to perform operations comprising:
transmitting an outbound datagram through a port of the firewall to open a circuit through the firewall;
receiving an inbound datagram through the open circuit from the external application; and
communicating with the external application through the open circuit;
wherein the external computer is coupled to a network outside of the firewall and the internal computer is coupled to the network inside of the firewall.

18. The system of claim 17, wherein the internal application is further configured to perform operations comprising:
receiving an inbound datagram through the open circuit from at least another external application; and
communicating with the at least another external application through the open circuit.

19. The system of claim 17, wherein the internal application is further configured to perform operations comprising:
distributing to the external application data comprising one or more of software, streaming audio, and streaming video.

20. The system of claim 17, wherein the internal application is further configured to perform operations comprising:
transmitting one or more additional outbound datagrams through the open circuit to reset a TTL counter associated with the firewall.
